(19) United States
(12) Patent Application Publication
(10) Pub. No.: US 2007/0208660 A1
(43) Pub. Date: Sep. 6, 2007

(54) Correct your bad credit

(76) Inventor: Charles Burnett Perry, Riverdale, MD (US)

Correspondence Address: CHARLES B. PERRY, P.O. BOX 939, RIVERDALE, MD, 20738, US

(21) Appl. No.: 11/365,788

(22) Filed: Mar. 2, 2006

(51) Int. Cl. G06Q 40/00

(52) U.S. Cl. 705/38

(57) ABSTRACT

Let me point out what is new about this process versus the old credit repair process: A) In the old process of credit repair you need to write numerous letters pertaining to each account and/or use codes stipulated in the fair credit reporting act to respond or challenge the credit bureaus. Each letter must be neatly typed or handwritten using the properly codes and/or pre-printed letters (if you bought the software). This usually took a lot of time and confusion for writing the software pre-printed letters and use codes that correspond to each item or letter. You could spend not only a lot of time writing and/or completing letters, you also had to buy stamps for each letter, with could add up to a lot of postage. Also, it did specifically show or explain how to successfully remove a “bankruptcy” from your credit report. B) The new process eliminates wasted time, confusion, and remembering all those codes for each item. It's very simple to use, by just using the investigation forms in the back of each credit report and listing “all” the bad credit items at once on it, instead of 2 or 3 items at a time every 3 or 4 months. And it also explains how to successfully remove a “bankruptcy” from your credit report step by step using the same new process above. This way you use less postage to mail to the three credit bureaus Equifax, Experian and Transunion and you are done. Keep in mind, the majors credit bureaus don't want people to know that you can challenge any item on your credit report, regardless of whether it's yours or not yours. Credit bureaus say, that if you have bad credit (thats yours), that it can not be deleted until 7 or 10 years depending on the nature of the item(s). But what they don't tell you is, you have a “right” to challenge any item on your report regardless of whether it's yours or not yours . . . because in America every one is innocent until proven guilty and that's the same way with the credit bureaus. Even though it shows bad credit on your credit report “it can and must be verified to prove that it is yours . . . “it's your right under the law” (Fair Credit Reporting Act).

To correct your bad credit, follow the six simple steps below:

1) Order all three credit reports from the major credit bureaus Equifax, Experian, Transunion.

2) Once you receive all three credit reports, quickly analyze them and look at all the bad/negative credit items listed.

At the end of each credit report there will be an investigation request form. Xerox as many pages needed of this form to list “all” of your bad credit items, with the company's name and the account number very neatly. Because each form with each credit bureau is different, put an “X” in each box on the form of that account that says, “Not Mine” for Equifax, “Not My Account” for Experian, and “Not My Account” for Transunion.

### EXAMPLE

On Equifax you can list up to 6 accounts on the form; so you would write in the company's name and the account they have and put an “X” in the box that say's “Not Mine” . . . then continue to list all of your bad credit items listed on Equifax and then with the other credit reports (Experian and Transunion).

To remove a bankruptcy from your credit report, you must first list the bankruptcy (make sure you put an “X” in the box), then list all the bad credit items on your credit report that does not show “Included in Bankruptcy”, and go thru steps 3-6; after you get the results from the credit bureau in 30-days,

Then go back and list all the items on your credit report that state “Included in Bankruptcy” only (make sure you put an “X” in the box) and go thru steps 3-6 again.

3) When finished make copies for your records.

4) Mail in the originals (credit reports and form(s)) to each of the credit bureaus as soon as possible.

5) The wait, by law (Fair Credit Reporting Act) the credit bureaus must verify each account that you listed on that form you sent in within 30-days. They will either delete the item(s) or they will verify the item(s).

6) Once you completed steps 1 thru 5, pay off your bills in full and/or repeat steps 1 thru 5 every 4 months, if necessary, and keep paying your bills on time. By following these simple steps 1 thru 5, (100%), you should never have bad credit again.

1. I claim that this is a new process for credit repair that works by using the following 6 steps to “correct your bad credit”.
